(19) United States
(12) Patent Application Publication
(10) Pub. No.: US 2022/0002604 A1
(43) Pub. Date: Jan. 6, 2022

(54) COMPOSITES, METHODS OF MANUFACTURE THEREOF, AND ARTICLES CONTAINING THE COMPOSITES

(71) Applicant: ROGERS CORPORATION, Chandler, AZ (US)

(72) Inventors: Ming Wei, Mansfield Center, CT (US); Ian Smith, Ashford, CT (US); Sharon Soong, Natick, MA (US)

(21) Appl. No.: 17/475,804

(22) Filed: Sep. 15, 2021

Related U.S. Application Data
(63) Continuation of application No. 16/095,776, filed on Oct. 23, 2018.
(60) Provisional application No. 62/328,717, filed on Apr. 28, 2016.
(60) Provisional application No. 62/429,424, filed on Dec. 2, 2016.

(51) Int. Cl. C09K 5/06; B01J 13/04; B01J 13/14; B01J 13/22; C08L 9/06; C08L 23/06; C08L 23/16; C08L 67/00; C08L 75/04

(52) U.S. Cl. CPC C09K 5/063; B01J 13/046; B01J 13/14; B01J 13/22; C08L 9/06; B32B 25/00; C08L 23/16; C08L 67/00; C08L 75/04; Y10T 428/1352; Y10T 428/1386; C08L 23/06

(57) ABSTRACT

A composite includes a polymer; and a phase-change composition including an unencapsulated first phase-change material, and an encapsulated second phase-change material.

### CROSS-REFERENCE TO RELATED APPLICATIONS

This application is a continuation application of U.S. application Ser. No. 16/095,776, filed on Oct. 23, 2018, which application claimed priority to PCT/US2017/027866, filed Apr. 17,2017, which claimed priority to U.S. Provisional Patent Application No. 62/328,717, filed Apr. 28, 2016 and U.S. Provisional Patent Application No. 62/429,424, filed Dec. 2, 2016, all of which are incorporated by reference in their entireties herein.

### BACKGROUND

This disclosure relates to composites comprising phase change materials, and methods of manufacture thereof.

Circuit designs for electronic devices such as televisions, radios, computers, medical instruments, business machines, and communications equipment have become increasingly smaller and thinner The increasing power of such electronic components has resulted in increasing heat generation. Moreover, smaller electronic components are being densely packed into ever smaller spaces, resulting in more intense heat generation. At the same time, temperature-sensitive elements in an electronic device can need to be maintained within a prescribed operating temperature in order to avoid significant performance degradation or even system failure. Consequently, manufacturers are continuing to face the challenge of dissipating heat generated in electronic devices.

Accordingly, there remains a need for composites comprising a phase change material for thermal management of circuits and electronic devices.

### BRIEF SUMMARY

A composite includes a polymer; and a phase-change composition including an unencapsulated first phase-change material, and an encapsulated second phase-change material.

An article includes a composite including a polymer; and a phase-change composition including an unencapsulated first phase-change material, and an encapsulated second phase-change material.

A method of manufacturing the composite or the article includes combining the polymer or a prepolymer composition optionally including a solvent, the unencapsulated first phase-change material, the encapsulated second phase-change material, and optionally an additive to form a mixture; forming an article from the mixture; and optionally removing the solvent to manufacture the composite.

The above described and other features are exemplified by the following figure and detailed description.

### BRIEF DESCRIPTION OF THE DRAWINGS

The following is a brief description of the drawings which are presented for the purposes of illustrating the exemplary embodiments disclosed herein and not for the purposes of limiting the same.

FIG. 1 is a graph showing heat flow (J/g) as a function of temperature (° C.) obtained by differential scanning calorimetry (DSC) on an exemplary embodiment of a composite composed of a styrene-butadiene (Kraton D1118)/eicosane/encapsulated phase-change material (MPCM 37D).

### DETAILED DESCRIPTION

The inventors hereof have found that a phase-change composition that includes an unencapsulated phase-change material (PCM) and an encapsulated phase-change material can advantageously be combined with a polymer matrix to prepare composites having a good combination of mechanical properties and a high heat of fusion at the phase transition temperature. These composites are especially suitable for providing excellent thermal protection to electronic devices.

Accordingly, disclosed herein is a phase change material-based composite. The composite includes a phase-change composition comprising an unencapsulated first phase-change material and an encapsulated second phase-change material. The phase change composition is present, preferably evenly dispersed, in a polymer matrix.

A phase-change material is a substance with a high heat of fusion, and which is capable of absorbing and releasing high amounts of latent heat during melting and solidification, respectively. During the phase change, the temperature of the phase-change material remains nearly constant. The phase change material inhibits or stops the flow of thermal energy through the material during the time the phase change material is absorbing or releasing heat, typically during the material's change of phase. In some instances, a phase change material can be capable of inhibiting heat transfer during a period of time when the phase change material is absorbing or releasing heat, typically as the phase change material undergoes a transition between two states. This action is typically transient and will occur until a latent heat of the phase change material is absorbed or released during a heating or cooling process. Heat can be stored or removed from a phase change material, and the phase change material typically can be effectively recharged by a source of heat or cold.

Phase change materials thus have a characteristic transition temperature. The term “transition temperature,” or “phase change temperature” refers to an approximate temperature at which a material undergoes a transition between two states. In some embodiments, e.g. for a commercial paraffin wax of mixed composition, the transition “temperature” can be a temperature range over which the phase transition occurs.

In principle, it is possible to use phase-change materials having a phase change temperature of −100° C. to 150° C. in the composites. For use in electrical and electronic components, the phase-change materials incorporated into the composites can have a phase change temperature of 0° C. to 115° C., 10° C. to 105° C., 20° C. to 100° C., or 30° C. to 95° C. In an embodiment, the phase-change composition has a melting temperature of 5° C. to 70° C., 25° C. to 50° C., or 30° C. to 45° C., or 35° C. to 40° C.

The selection of a phase-change material is typically dependent upon the transition temperature that is desired for a particular application that is going to include the phase-change material. For example, a phase-change material having a transition temperature near normal body temperature or around 37° C. can be desirable for electronics applications to prevent user injury and protect overheating components. A phase change material according to some embodiments can have a transition temperature in the range of −5 to 150° C. In an embodiment, the transition temperature is 0° C. to 90° C. In another embodiment, the transition temperature is 30 to 70° C. In another embodiment, the phase-change material has a transition temperature of 35 to 60° C.

The transition temperature can be expanded or narrowed by modifying the purity of the phase-change material, molecular structure, blending of phase-change materials, and any mixtures thereof.

The first phase-change material and the second phase-change material can be identical or different. Similarly the first phase-change material or the second phase-change material can individually be selected to be a single material or a mixture of materials. For certain embodiments, the first phase change material, and the second phase change material are different materials. By selecting two or more different materials and forming a mixture, the temperature stabilizing range of the phase-change material can be adjusted for any desired application. A temperature stabilizing range can include a specific transition temperature or a range of transition temperatures. The resulting mixture can exhibit two or more different transition temperatures or a single modified transition temperature when incorporated in the composites described herein.

In some embodiments, it can be advantageous to have multiple or broad transition temperatures. If a single narrow transition temperature is used, this can cause thermal/energy buildup before the transition temperature is reached. Once the transition temperature is reached, then energy will be absorbed until the latent energy is consumed and the temperature will then continue to increase. Broad or multiple transition temperatures allow for temperature regulation and thermal absorption as soon the temperature starts to increase, thereby alleviating any thermal/energy buildup. Multiple or broad transition temperatures can also more efficiently help conduct heat away from a component by overlapping or staggering thermal absorptions. For instance for a composite containing a first phase-change material (PCM1) which absorbs at 35-40° C. and a second phase-change material (PCM2) which absorbs at 38-45° C., PCM1 will start absorbing and controlling temperature until a majority of the latent heat is used, at which time PCM2 will start to absorb and conduct energy from PCM1 thereby rejuvenating PCM1 and allowing it to keep functioning.

The selection of the phase-change material can be dependent upon the latent heat of the phase change material. A latent heat of the phase change material typically correlates with its ability to absorb and release energy/heat or modify the heat transfer properties of the article. In some instances, the phase change material can have a latent heat of fusion that is at least 20 J/g, such as at least 40 J/g, at least 50 J/g, at least 70 J/g, at least 80 J/g, at least 90 J/g, or at least 100 J/g. Thus, for example, the phase change material can have a latent heat of 20 J/g to 400 J/g, such as 60 J/g to 400 J/g, 80 J/g to 400 J/g, or 100 J/g to 400 J/g.

Phase-change materials that can be used include various organic and inorganic substances. Examples of phase change materials include hydrocarbons (e.g., straight-chain alkanes or paraffinic hydrocarbons, branched-chain alkanes, unsaturated hydrocarbons, halogenated hydrocarbons, and alicyclic hydrocarbons), silicone wax, alkanes, alkenes, alkynes, arenes, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids (caproic acid, caprylic acid, lauric acid, myristic acid, palmitic acid, stearic acid, arachidic acid, behenic acid, lignoceric acid and cerotic acid, etc.), fatty acid esters (methyl caprylate, methyl caprate, methyl laurate, methyl myristate, methyl palmitate, methyl stearate, methyl arachidate, methyl behenate, methyl lignocerate, and the like), fatty alcohols (capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol, and the like), dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and mixtures thereof. In an embodiment a phase-change material used in the composite is an organic substance.

Paraffinic phase-change materials can be a paraffinic hydrocarbon, that is, a hydrocarbon represented by the formula CₙHₙ₊₂, where n can range from 10 to 44 carbon atoms. The melting point and heat of fusion of a homologous series of paraffin hydrocarbons is directly related to the number of carbon atoms, as shown in the following table.

TABLE 1
Melting Points of Paraffinic Hydrocarbons

| | No. of | Melting |
|---|---|---|
| Paraffinic | Carbon | Point |
| Hydrocarbon | Atoms | (° C.) |
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

In an embodiment, the phase-change material can comprise a paraffinic hydrocarbon having 15 to 40 carbon atoms, 18 to 35 carbon atoms, or 18 to 28 carbon atoms. The paraffinic hydrocarbon can be a single hydrocarbon or a mixture of hydrocarbons.

The first and the second phase-change material are present in two forms, an encapsulated form and in unencapsulated (“raw” form). Encapsulation of the phase-change material essentially creates a container for the phase-change material so that regardless of whether the phase-change material is in the solid or liquid state, the phase-change material is contained. Methods for encapsulating materials, such as phase-change materials, are known in the art (see for example, U.S. Pat. Nos. 5,911,923 and 6,703,127). Microencapsulated and macroencapsulated phase-change materials are also available commercially (e.g., from Microtek Laboratories, Inc.) Macrocapsules have an average particle size of 1000 to 10,000 micrometers, whereas microcapsules have an average particle size less than 1000 micrometers. In an embodiment the encapsulated phase-change material is encapsulated in a microcapsule and the mean particle size of the microcapsules is 1 to 100 micrometers, or 2 to 50 micrometers, or 5 to 40 micrometers. In an embodiment, the encapsulated phase-change material is MPCM 37D (Microtek Laboratories, Inc., Ohio). Herein, mean particle size is a volume weighted mean particle size, determined for example using a Malvern Mastersizer 2000 Particle Analyzer, or equivalent instrumentation. Phase-change material loading of microcapsules or macrocapusles is at least 50 wt %, or 75 to 99 wt %, more particularly 80 to 98 wt %, and in some embodiments at least 85 to 99 wt %, each based on total weight of the capsule.

The phase-change composition can comprise 1 wt % to 95 wt % of the unencapsulated first phase-change material and 5 to 95 wt % of the encapsulated second phase-change material, based on the total weight of the phase-change composition; or 1 wt % to 40 wt % of the unencapsulated first phase-change material and 60 wt % to 95 wt % of the encapsulated second phase-change material.

The composite further comprises a polymer matrix. The polymer can be present in the composite in an amount of 5 weight percent (wt %) to 50 wt %, or 5 wt % to 20 wt %, or 8 wt % to 20 wt %, the weight percents being based on the total weight of the composite. The phase-change composition can be present in an amount of 50 wt % to 95 wt %, or 80 wt % to 95 wt %, or 80 to 92 wt %, the weight percents being based on the total weight of the composite.

Any polymer suitable for the intended end use can be used. Examples of thermoplastic polymers that can be used include polyacetals (e.g., polyoxyethylene and polyoxymethylene), poly(C₁₋₆ alkyl)acrylates, polyacrylamides (including unsubstiuted and mono-N- and di-N-(C₁₋₈ alkyl)acrylamides), polyacrylonitriles, polyamides (e.g., aliphatic polyamides, polyphthalamides, and polyaramides), polyamideimides, polyanhydrides, polyarylene ethers (e.g., polyphenylene ethers), polyarylene ether ketones (e.g., polyether ether ketones (PEEK) and polyether ketone ketones (PEKK)), polyarylene ketones, polyarylene sulfides (e.g., polyphenylene sulfides (PPS)), polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetherimides (including copolymers such as polyetherimide-siloxane copolymers), polyimides (including copolymers such as polyimide-siloxane copolymers), poly(C₁₋₆ alkyl)methacrylates, polymethacrylamides (including unsubstiuted and mono-N- and di-N-(C₁₋₈ alkyl)acrylamides), cyclic olefin polymers (including polynorbornenes and copolymers containing norbornenyl units, for example copolymers of a cyclic polymer such as norbornene and an acyclic olefin such as ethylene or propylene), polyolefins (e.g., polyethylenes, polypropylenes, and their halogenated derivatives (such as polytetrafluoroethylenes), and their copolymers, for example ethylene-alpha-olefin copolymers, polyoxadiazoles, polyoxymethylenes, polyphthalides, polysilazanes, polysiloxanes (silicones), polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, vinyl polymers (including polyvinyl alcohols, polyvinyl esters, polyvinyl ethers, polyvinyl halides (e.g, polyvinyl fluoride), polyvinyl ketones, polyvinyl nitriles, polyvinyl thioethers, and polyvinylidene fluorides), or the like. A combination comprising at least one of the foregoing thermoplastic polymers can be used.

Thermoset polymers can be used. Thermoset polymers are derived from thermosetting prepolymers (resins) that can irreversibly harden and become insoluble with polymerization or cure, which can be induced by heat or exposure to radiation (e.g., ultraviolet light, visible light, infrared light, or electron beam (e-beam) radiation). Thermoset polymers include alkyds, bismaleimide polymers, bismaleimide triazine polymers, cyanate ester polymers, benzocyclobutene polymers, diallyl phthalate polymers, epoxies, hydroxymethylfuran polymers, melamine-formaldehyde polymers, phenolics (including phenol-formaldehyde polymers such as novolacs and resoles), benzoxazines, polydienes such as polybutadienes (including homopolymers and copolymers thereof, e.g. poly(butadiene-isoprene)), polyisocyanates, polyureas, polyurethanes, silicones, triallyl cyanurate polymers, triallyl isocyanurate polymers, polyimides, certain silicones, and copolymerizable prepolymers (e.g., prepolymers having ethylenic unsaturation, such as unsaturated polyesters polyimides), or the like. The prepolymers can be copolymerized or crosslinked with a reactive monomer such as styrene, alpha-methylstyrene, vinyltoluene, chlorostyrene, acrylic acid, (meth)acrylic acid, a (C₁₋₆ alkyl)acrylate, a (C₁₋₆ alkyl) methacrylates, acrylonitrile, vinyl acetate, allyl acetate, triallyl cyanurate, triallyl isocyanurate, or acrylamide. The molecular weight of the prepolymers can be 400 to 10,000 Daltons on average.

Suitable elastomers can be elastomeric random, grafted, or block copolymers. Examples include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like.

Elastomeric block copolymers comprise a block (A) derived from an alkenyl aromatic compound and a block (B) derived from a conjugated diene. The arrangement of blocks (A) and (B) include linear and graft structures, including radial teleblock structures having branched chains. Examples of linear structures include diblock (A-B), triblock (A-B-A or B-A-B), tetrablock (A-B-A-B), and pentablock (A-B-A-B-A or B-A-B-A-B) structures as well as linear structures containing 6 or more blocks in total of A and B. Specific block copolymers include diblock, triblock, and tetrablock structures, and specifically the A-B diblock and A-B-A triblock structures. In some embodiments, the elastomer is a styrenic block copolymer (SBC) consisting of polystyrene blocks and rubber blocks. The rubber blocks can be polybutadiene, polyisoprene, their hydrogenated equivalents, or a combination comprising at least one of the foregoing. Examples of styrenic block copolymers include styrene-butadiene block copolymers, e.g. Kraton D SBS polymers (Kraton Performance Polymers, Inc.); styrene-ethylene/butadiene block copolymers, e.g., Kraton G SEBS (Kraton Performance Polymers, Inc.); and styrene-isoprene block copolymers, e.g., Kraton D SIS polymers (Kraton Performance Polymers, Inc.). In certain embodiments, the polymer is a styrene butadiene block copolymer, e.g. Kraton D1118.

In an embodiment, the polymers used in the present invention have low polarity. The low polarity of the polymer enables compatibility between the polymer and a phase-change material of non-polar nature. The capacity of the polymers to efficiently retain the phase-change material within their own matrix confers to the composites an excellent heat management performance over long periods of time.

In certain embodiments, the polymer of the matrix is Kraton, polybutadiene, EPDM, natural rubber, polyethylene oxide, or polyethylene.

The composite can further comprise an additional filler, for example a filler to adjust the dielectric properties of the composite. A low coefficient of expansion filler, such as glass beads, silica or ground micro-glass fibers, can be used. A thermally stable fiber, such as an aromatic polyamide, or a polyacrylonitrile can be used. Representative fillers include titanium dioxide (rutile and anatase), barium titanate, strontium titanate, fused amorphous silica, corundum, wollastonite, aramide fibers (e.g., KEVLAR™ from DuPont), fiberglass, Ba₂Ti₉O₂₀, quartz, aluminum nitride, silicon carbide, beryllia, alumina, magnesia, mica, talcs, nanoclays, aluminosilicates (natural and synthetic), and fumed silicon dioxide (e.g., Cab-O-Sil, available from Cabot Corporation), each of which can be used alone or in combination.

The fillers can be in the form of solid, porous, or hollow particles. The particle size of the filler affects a number of important properties including coefficient of thermal expansion, modulus, elongation, and flame resistance. In an embodiment, the filler has an average particle size of 0.1 to 15 micrometers, specifically 0.2 to 10 micrometers. A combination of fillers having a bimodal, trimodal, or higher average particle size distribution can be used. The filler can be included in an amount of 0.1 to 80 wt %, specifically 1 to 65 wt %, or 5 to 50 wt %, based on a total weight of the composite.

The composition used to form the composite or the composite can further optionally comprise additives such as flame retardants, cure initiators, crosslinking agents, viscosity modifiers, wetting agents, and antioxidants. The particular choice of additives depends on the polymer used, the particular application of the composite, and the desired properties for that application, and are selected so as to enhance or not substantially adversely affect the electrical properties of the circuit subassemblies, such as thermal conductivity, dielectric constant, dissipation factor, dielectric loss, or other desired properties.

Representative flame retardant additives include bromine-, phosphorus-, and metal oxide-containing flame retardants. Suitable bromine-containing flame retardants are generally aromatic and contain at least two bromines per compound. Some that are commercially available are from, for example, Albemarle Corporation under trade names Saytex BT-93W (ethylenebistetrabromonaphthalamide), Saytex 120 (tetradecaboromodiphenoxybenzene), and Great Lake under trade name BC-52, BC-58, Esschem Inc under the trade name FR1025.

Suitable phosphorus-containing flame retardants include various organic phosphorous compounds, for example an aromatic phosphate of the formula (GO)₃P═O, wherein each G is independently an C1-36 alkyl, cycloalkyl, aryl, alkylaryl, or arylalkyl group, provided that at least one G is an aromatic group. Two of the G groups can be joined together to provide a cyclic group, for example, diphenyl pentaerythritol diphosphate. Other suitable aromatic phosphates can be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like. Examples of suitable di- or polyfunctional aromatic phosphorous-containing compounds include resorcinol tetraphenyl diphosphate (RDP), the bis (diphenyl) phosphate of hydroquinone, and the bis(diphenyl) phosphate of bisphenol-A, respectively, their oligomeric and polymeric counterparts, and the like.

Metal phosphinate salts can also be used. Examples of phosphinates are phosphinate salts such as for example alicyclic phosphinate salts and phosphinate esters. Further examples of phosphinates are diphosphinic acids, dimethylphosphinic acid, ethylmethylphosphinic acid, diethylphosphinic acid, and the salts of these acids, such as for example the aluminum salts and the zinc salts. Examples of phosphine oxides are isobutylbis(hydroxyalkyl) phosphine oxide and 1,4-diisobutylene-2,3,5,6-tetrahydroxy-1,4-diphosphine oxide or 1,4-diisobutylene-1,4-diphosphoryl-2,3,5,6-tetrahydroxycyclohexane. Further examples of phosphorous-containing compounds are NH1197® (Chemtura Corporation), NH1511® (Chemtura Corporation), NcendX P-30® (Albemarle), Hostaflam OP5500® (Clariant), Hostaflam OP910® (Clariant), EXOLIT 935 (Clariant), and Cyagard RF 1204®, Cyagard RF 1241® and Cyagard RF 1243R (Cyagard are products of Cytec Industries). In a particularly advantageous embodiment, a halogen-free composite has excellent flame retardance when used with EXOLIT 935 (an aluminum phosphinate). Still other flame retardants include melamine polyphosphate, melamine cyanurate, Melam, Melon, Melem, guanidines, phosphazanes, silazanes, DOPO (9,10-dihydro-9-oxa-10 phosphenathrene-10-oxide), and DOPO (10-5 dihydroxyphenyl, 10-H-9 oxaphosphaphenanthrenelo-oxide).

Suitable metal oxide flame retardants are magnesium hydroxide, aluminum hydroxide, zinc stannate, and boron oxide. A flame retardant additives can be present in an amount known in the art for the particular type of additive used.

Exemplary cure initiators include those useful in initiating cure (cross-linking) of the polymers, in the composite. Examples include, but are not limited to, azides, peroxides, sulfur, and sulfur derivatives. Free radical initiators are especially desirable as cure initiators. Examples of free radical initiators include peroxides, hydroperoxides, and non-peroxide initiators such as 2,3-dimethyl-2, 3-diphenyl butane. Examples of peroxide curing agents include dicumyl peroxide, alpha, alpha-di(t-butylperoxy)-m,p-diisopropylbenzene, 2,5-dimethyl-2,5-di(t-butylperoxy)hexane-3, and 2,5-dimethyl-2,5-di(t-butylperoxy)hexyne-3, and mixtures comprising one or more of the foregoing cure initiators. The cure initiator, when used, can be present in an amount of 0.01 wt % to 5 wt %, based on the total weight of the composite.

Crosslinking agents are reactive monomers or polymers that increase the cross-link density upon cure of the dielectric material. In one embodiment, such reactive monomers or polymers are capable of co-reacting with the polymer in the composite. Examples of suitable reactive monomers include styrene, divinyl benzene, vinyl toluene, divinyl benzene, triallylcyanurate, diallylphthalate, and multifunctional acrylate monomers (such as Sartomer compounds available from Sartomer Co.), among others, all of which are commercially available. Useful amounts of crosslinking agents are 0.1 to 50 wt %, based on the total weight of the composite.

Exemplary antioxidants include radical scavengers and metal deactivators. A non-limiting example of a free radical scavenger is poly[[6-(1,1,3,3-tetramethylbutyl)amino-s-triazine-2,4-dyil][(2,2,6,6,-tetramethyl-4-piperidyl)imino]hexamethylene[(2,2,6,6-tetramethyl-4-piperidyl)imino]], commercially available from Ciba Chemicals under the tradename Chimassorb 944. A non-limiting example of a metal deactivator is 2,2-oxalyldiamido bis[ethyl 3-(3,5-di-t-butyl-4-hydroxyphenyl)propionate] commercially available from Chemtura Corporation under the tradename Naugard XL-1. A single antioxidant or a mixture of two or more antioxidants can be used. Antioxidants are typically present in amounts of up to 3 wt %, specifically 0.5 to 2.0 wt %, based on the total weight of the composite.

Coupling agents can be present to promote the formation of or participate in covalent bonds connecting a metal surface or filler surface with a polymer. Exemplary coupling agents include 3-mercaptopropylmethyldimethoxy silane and 3-mercaptopropyltrimethoxy silane and hexamethylenedisilazanes.

Additionally, the composite can further optionally comprise a layer at least partially coating a surface of the composite. In some embodiments, the layer completely coats the surface of the composite. In other embodiments, the layer completely coats all surfaces of the composite. The layer can be effective in reducing or preventing migration of a phase change material in the composite through the coated surface of the composite.

The layer can be a polymer film laminated to the surface with an adhesive. The polymer film can, for example, comprise a film of a crystallized polymer. Examples of the polymer include polyethylene terephthalate, polyurethane, high density polyethylene (HDPE), medium density polyethylene (MDPE), polypropylene (PP), nylon, and combinations of the foregoing. The thickness of the polymer film can be 1 μm to 500 μm, preferably 3 μm to 200 μm, more preferably 5 μm to 50 μm. The adhesive can be a rubber-based pressure sensitive adhesive or an acrylic-based pressure sensitive adhesive.

Alternatively, the layer can be a coating material applied to at least partially coat a surface of the composite. The coating material can be a polymer. Examples of suitable polymers include an ultraviolet (UV)-curing polymer, nitrile rubber (NBR) or hydrogenated nitrile butadiene rubber (HNBR), polyurethane, ethylene propylene diene monomer rubber (EPDM), polybutadiene, epoxy, acrylic, nanoclay in NBR rubber, fumed silica in NBR rubber, and a combination of the foregoing. The coating material can also be a composite comprising a phase change material. An example of a coating composite includes Composite C, disclosed below in Example 2. The layer can be coated to a thickness of 1 μm to 500 μm, preferably 3 μm to 200 μm, more preferably 5 μm to 50 μm.

The composite can be manufactured by combining the polymer or prepolymer composition, the phase-change composition or the unencapsulated first phase-change material and the encapsulated second phase-change material, and any additives to manufacture the composite. The combining can be by any suitable method, such as blending, mixing, or stirring. In an embodiment, the components used to form the composite, including the polymer or prepolymer composition and the phase-change composition or the unencapsulated first phase-change material and the encapsulated second phase-change material, can be combined by being dissolved or suspended in a solvent to provide a coating mixture or solution. The solvent is selected so as to dissolve the polymer or pre-polymers, disperse the phase-change composition, or the unencapsulated first phase-change material and the encapsulated second phase-change material, and any other optional additives that can be present, and to have a convenient evaporation rate for forming and drying. A non-exclusive list of possible solvents is xylene; toluene; methyl ethyl ketone; methyl isobutyl ketone; hexane, and higher liquid linear alkanes, such as heptane, octane, nonane, and the like; cyclohexane; isophorone; various terpene-based solvents; and blended solvents. Specific exemplary solvents include xylene, toluene, methyl ethyl ketone, methyl isobutyl ketone, and hexane, and still more specifically xylene and toluene. The concentration of the components of the composition in the solution or dispersion is not critical and will depend on the solubility of the components, the filler level used, the method of application, and other factors. In general, the solution comprises 10 to 80 wt % solids (all components other than the solvent), more specifically 50 to 75 wt % solids, based on the total weight of the solution.

For example, the composite can be implemented as a coating, laminate, film, or sheet using any suitable coating, laminating, layering, and other techniques. Application techniques and forms can include spray coating, air atomized spraying, airless atomized spraying, electrostatic spraying, slot die coating, contact slot coating, curtain coating, knife coating, roller coating, kiss coating, transfer coating, foam coating, brushing, screen-printing, padding, dipping or immersion, saturating, printing, pressure or gravity feed nozzles/guns, hot melt applicators, pump guns, manually operated guns, syringes, needle guns, various shape and size nozzles, molding, overmolding, injection molding, RIM, prepreg, Resin infusion process such as resin transfer molding (RTM), vacuum infusion process (VIP) and vacuum assisted RTM (VARTM), pultrusion, extrusion, plasma, and the like.

In certain embodiments, hot melt extrusion coating is used to make a film of the composite.

The composite can be formed into an article by known methods, for example extruding, molding, or casting. For example, the composite can be formed into a layer by casting onto a carrier from which it is later released, or alternatively onto a substrate such as a conductive metal layer that will later be formed into a layer of a circuit structure.

After the article or layer is formed, any solvent is allowed to evaporate under ambient conditions, or by forced or heated air, to form the composite. The layer can be uncured or partially cured (B-staged) in the drying process, or the layer can be partially or fully cured, if desired, after drying. The layer can be heated, for example at 20 to 200° C., specifically 30 to 150° C., more specifically 40 to 100° C. The resulting composite can be stored prior to use, for example lamination and cure, partially cured and then stored, or laminated and fully cured.

Optionally, a coating layer can be applied to at least a part of a surface of the composite or article. In some embodiments, the layer completely coats the surface of the composite or article. In other embodiments, the layer completely coats all surfaces of the composite or article. Applying the coating layer can comprise laminating a polymer film to the surface with an adhesive. Applying the coating layer can comprise applying a coating material to the surface.

In some embodiments, the composite can have a heat of fusion of at least 100 J/g, preferably at least 170 J/g, more preferably at least 220 J/g, yet more preferably at least 240 J/g.

The composite can be used in a variety of applications. The composites can be used in a wide variety of electronic devices and any other devices that generate heat to the detriment of the performance of the processors and other operating circuits (memory, video chips, telecom chips, and the like). Examples of such electronic devices include cell phones, PDAs, smart-phones, tablets, laptop computers, and other generally portable devices. However, the composites can be incorporated into virtually any electronic device that requires cooling during operation. For example, electronics used in automotive components, aircraft components, radar systems, guidance systems, and GPS devices incorporated into civilian and military equipment and other vehicles can benefit from aspects of the present invention such as engine control units (ECU), airbag modules, body controllers, door modules, cruise control modules, instrument panels, climate control modules, anti-lock braking modules (ABS), transmission controllers, and power distribution modules. The composites and articles thereof can also be incorporated into the casings of electronics or other structural components. In general, any device that relies on the performance characteristics of an electronic processor or other electronic circuit can benefit from the increased or more stable performance characteristics resulting from utilizing aspects of the composites disclosed herein.

The composites described herein can provide improved thermal stability to the device, resulting in the ability to avoid degradation of performance and lifetime of the electronic devices. The combination of an encapsulated and an unencapsulated phase-change materials is advantageous for use as thermal management materials, especially in electronics, in that the high crystallinity of the phase-change material allows for a combination of high latent heat capacity and energy absorption, which lead to improved heat management, lower heat buildup, fewer problems, and faster processor speeds. The polymer provides good handling capability and good mechanical properties.

The following example is merely illustrative of the composite and method of manufacture disclosed herein and is not intended to limit the scope hereof.

### EXAMPLES

The melting temperature and enthalpy (ΔH) of the transition of a material can be determined by differential scanning calorimetry (DSC), e.g., using a Perkin Elmer DSC 4000, or equivalent, according to ASTM D3418. The material subjected to DSC can be a phase-change material, an encapsulated phase-change material, the phase-change composition, or the composite.

### Example 1

A weight (30 grams) of Kraton D1118 (Kraton Performance Polymers, Inc.) is dissolved into 100 grams toluene. Eicosane (20 grams) is gradually added to the solution with stirring until formation of a homogenous solution. Then, 50 grams of a microencapsulated phase change material, MPCM 37D (Microtek Laboratories, Inc., Ohio), is added gradually with stirring until a homogeneous solution is obtained. The solution is cast onto a polyethylene terephthalate (PET) release liner and dried in a 110° C. oven for ten minutes.

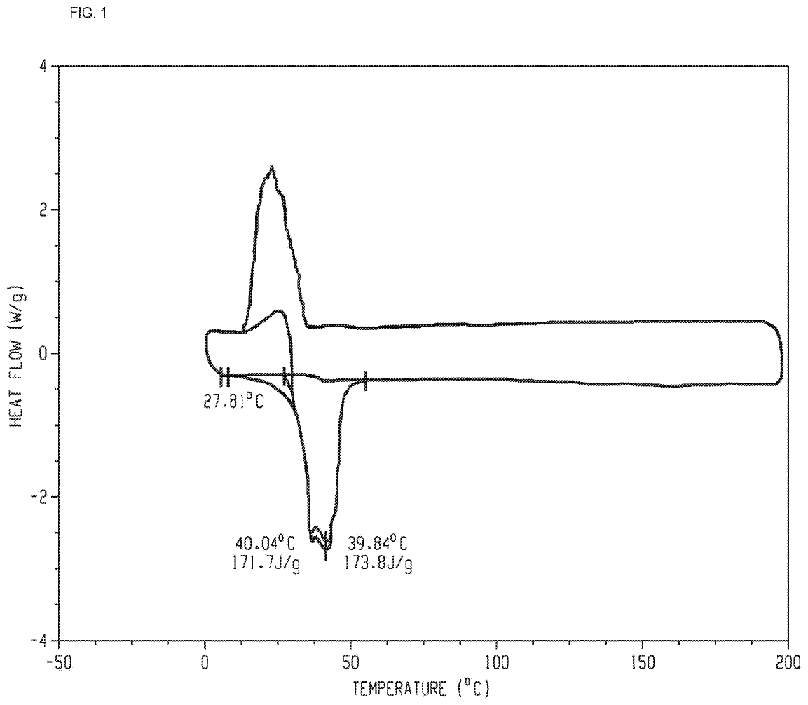

Differential scanning calorimetry (DSC) is performed to determine the heat of fusion of the blend according to ASTM D3418. The DSC results for the Kraton D1118/Eicosane/MPCM 37D blend are shown in FIG. 1. The Kraton D1118/Eicosane/MPCM 37D blend has a heat of fusion of 173.8 Joules/gram.

### Example 2

Samples of the Kraton D1118/Eicosane/MPCM 37D composite of Example 1 are partially coated on a surface with a polymer film laminated to the surface with an adhesive. The polymer film comprises polyethylene terephthalate, polyurethane, high density polyethylene (HDPE), medium density polyethylene (MDPE), nylon, or polypropylene (PP). The adhesive is a rubber-based pressure sensitive adhesive or acrylic-based pressure sensitive adhesive.

The resulting laminates are effective in reducing or preventing migration of the PCM through the surface of the composite.

Additional samples of the Kraton D1118/Eicosane/MPCM 37D composite of Example 1 are partially coated on a surface with a layer comprising a polymer comprising a UV-curing polymer, nitrile rubber (nitrile butadiene rubber (NBR) or hydrogenated nitrile butadiene rubber (HNBR)), polyurethane, ethylene propylene diene monomer (M-class) rubber (EPDM), polybutadiene, epoxy, acrylic, nanoclay in NIPOL rubber, or fumed silica in NIPOL rubber. The layer is coated to a thickness of 50 μm (or 5 to 200 μm if varied for the various samples).

TABLE 2
Coating formulation

| Component | Amount |
|---|---|
| Nitrile rubber | 0.97-0.997 |
| Antioxidant | 0.001-0.01 |
| light stabilizer | 0.001-0.01 |
| Black pigment | 0.001-0.01 |

The resulting layers are effective in reducing or preventing migration of the PCM through the surface of the composite.

The claims are further illustrated by the following Embodiments, which are non-limiting.

### Embodiment 1

A composite, comprising: a polymer; and a phase-change composition comprising an unencapsulated first phase-change material, and an encapsulated second phase-change material.

### Embodiment 2

The composite of embodiment 1, wherein the polymer is an elastomeric block copolymer, an elastomeric grafted copolymer, or an elastomeric random copolymer, preferably the polymer is styrene-butadiene block copolymer, polybutadiene, ethylene propylene diene terpolymer, natural rubber, polyethylene oxide, polyethylene, or a combination comprising at least one of the foregoing; more preferably the polymer is a styrene-butadiene block copolymer or styrene-ethylene/butadiene block copolymer.

### Embodiment 3

The composite of any one or more of embodiments 1 to 2, wherein the phase-change composition has a melting temperature of 5° C. to 70° C., preferably 25° C. to 50° C., more preferably 30° C. to 45° C.

### Embodiment 4

The composite of any one or more of embodiments 1 to 3, wherein the first phase-change material and the second phase-change material are different.

### Embodiment 5

The composite of any one or more of embodiments 1 to 4, wherein the first phase-change material has a first transition temperature and the second phase-change material has a second transition temperature, the first transition temperature and the second transition temperature being identical or different.

### Embodiment 6

The composite of any one or more of embodiments 1 to 5, wherein the first phase-change material comprises a C10-C35 alkane; preferably the first phase-change material comprises a C18-C28 alkane; more preferably the first phase-change material is n-eicosane.

### Embodiment 7

The composite of any one or more of embodiments 1 to 6, wherein the second phase-change material comprises a C10-C35 alkane; preferably the second phase-change material comprises a C18-C28 alkane; more preferably the second phase-change material is a paraffin having a melting temperature of 35° C. to 40° C.

### Embodiment 8

The composite of any one or more of embodiments 1 to 7, wherein the encapsulated second phase-change material has a mean particle size less than 50 micrometers; preferably 1 to 30 micrometers; most preferably 10 to 25 micrometers.

### Embodiment 9

The composite of any one or more of embodiments 1 to 8, comprising, based on the total weight of the composite, 5 weight percent to 50 weight percent, preferably 5 weight percent to 20 weight percent, of the polymer; and 50 weight percent to 95 weight percent, preferably 80 weight percent to 95 weight percent, of the phase-change composition.

### Embodiment 10

The composite of any one or more of embodiments 1 to 9, comprising, based on the total weight of the phase-change composition, 1 weight percent to 95 weight percent, preferably 1 weight percent to 60 weight percent, more preferably 1 weight percent to 40 weight percent, of the unencapsulated first phase-change material; and 5 weight percent to 95 weight percent, preferably 40 weight percent to 95 weight percent, more preferably 60 weight percent to 95 weight percent of the encapsulated second phase-change material.

### Embodiment 11

The composite of any one or more of embodiments 1 to 10, having a heat of fusion at the melting temperature of at least 100 J/g, preferably at least 220 J/g, more preferably at least 240 J/g.

### Embodiment 12

An article comprising the composite of any one or more of embodiments 1 to 11.

### Embodiment 13

The composite of any one or more of embodiments 1 to 11 or the article of embodiment 12, further comprising a layer at least partially coating a surface of the composite.

### Embodiment 14

The composite or article of embodiment 13, wherein the layer comprises a polymer film laminated to the surface with an adhesive, preferably the polymer is polyethylene terephthalate, polyurethane, high density polyethylene (HDPE), medium density polyethylene (MDPE), polypropylene (PP), nylon, or a combination of the foregoing.

### Embodiment 15

The composite or article of embodiment 13, wherein the layer comprises a coating material comprising a polymer.

### Embodiment 16

The composite or article of embodiment 15, wherein the polymer comprises a UV-curing polymer, nitrile rubber, polyurethane, ethylene propylene diene monomer (M-class) rubber (EPDM), polybutadiene, epoxy, acrylic, or a combination of the foregoing.

### Embodiment 17

A method of manufacturing the composite of any one or more of embodiments 1 to 11 and 13 to 16 or the article of any one or more of embodiments 12 to 16, the method comprising: combining the polymer or a prepolymer composition optionally comprising a solvent, the unencapsulated first phase-change material, the encapsulated second phase-change material, and optionally an additive to form a mixture; forming an article from the mixture; and optionally removing the solvent to manufacture the composite.

### Embodiment 18

The method of embodiment 17, further comprising crosslinking the prepolymer composition.

### Embodiment 19

The method of embodiment 17 or 18, further comprising applying a coating layer to at least a part of a surface of the composite.

In general, the articles and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

The singular forms “a,” “an,” and “the” include plural referents unless the context clearly dictates otherwise. “Or” means “and/or.” Unless defined otherwise, technical and scientific terms used herein have the same meaning as is commonly understood by one of skill in the art to which the claims belong. A “combination” is inclusive of blends, mixtures, alloys, reaction products, and the like. The values described herein are inclusive of an acceptable error range for the particular value as determined by one of ordinary skill in the art, which will depend in part on how the value is measured or determined, i.e., the limitations of the measurement system. The endpoints of all ranges directed to the same component or property are inclusive of the endpoints and intermediate values, and independently combinable.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosed subject matter is described herein in terms of some embodiments and representative examples, those skilled in the art will recognize that various modifications and improvements can be made to the disclosed subject matter without departing from the scope thereof. Additional features known in the art likewise can be incorporated. Moreover, although individual features of some embodiments of the disclosed subject matter can be discussed herein and not in other embodiments, it should be apparent that individual features of some embodiments can be combined with one or more features of another embodiment or features from a plurality of embodiments.

What is claimed is:

1. A composite, comprising:
5 weight percent to 50 weight percent of a polymer; and
50 weight percent to 95 weight percent of a phase-change composition comprising
an unencapsulated first phase-change material comprising a C10-C44 alkane, and
an encapsulated second phase-change material comprising a C10-C44 alkane,
wherein weight percents are based on the total weight of the composite, and
the composite has a heat of fusion at the melting temperature of at least 100 J/g.

2. The composite of claim 1, wherein
the polymer is an elastomeric block copolymer, an elastomeric grafted copolymer, an elastomeric random copolymer, styrene-butadiene block copolymer, polybutadiene, ethylene propylene diene terpolymer, natural rubber, polyethylene oxide, polyethylene, or a combination comprising at least one of the foregoing.

3. The composite of claim 1, wherein the polymer is not crosslinked.

4. The composite of claim 1, wherein the phase-change composition has a melting temperature of 5° C. to 70° C.

5. The composite of claim 1, wherein the first phase-change material and the second phase-change material are different.

6. The composite of claim 1, wherein the first phase-change material has a first transition temperature and the second phase-change material has a second transition temperature, the first transition temperature and the second transition temperature being identical or different.

7. The composite of claim 1, wherein
the first phase-change material comprises a C10-C35 alkane.

8. The composite of claim 1, wherein
the second phase-change material comprises a C10-C35 alkane.

9. The composite of claim 1, wherein the encapsulated second phase-change material has a mean particle size less than 50 micrometers.

10. The composite of claim 1, comprising, based on the total weight of the composite,
5 weight percent to 20 weight percent, of the polymer; and
80 weight percent to 95 weight percent, of the phase-change composition.

11. The composite of claim 1, comprising, based on the total weight of the phase-change composition,
1 weight percent to 95 weight percent of the unencapsulated first phase-change material; and
5 weight percent to 95 weight percent of the encapsulated second phase-change material.

12. A film comprising the composite of claim 1.

13. The film of claim 12, further comprising a layer at least partially coating a surface of the film.

14. The film of claim 13, wherein the layer comprises a polymer film laminated to the surface with an adhesive

15. The layer of claim 14, wherein the layer comprises a coating material comprising a polymer or a coating composite comprising a phase change material.

16. The layer of claim 15, wherein the coating material comprises a polymer comprising a UV-curing polymer, nitrile rubber, polyurethane, ethylene propylene diene monomer (M-class) rubber (EPDM), polybutadiene, epoxy, acrylic, or a combination of the foregoing.

17. A method of manufacturing the composite of claim 1, the method comprising:
combining
the polymer or a prepolymer composition optionally comprising a solvent,
the unencapsulated first phase-change material,
the encapsulated second phase-change material, and
optionally an additive to form a mixture;
forming an article from the mixture; and
optionally removing the solvent to manufacture the composite.

18. The method of claim 18, further comprising crosslinking the prepolymer composition.

19. The method of claim 18, further comprising applying a coating layer to at least a part of a surface of the composite.

20. An article comprising the composite of claim 1.

21. The article of claim 20 that is an electronic device.

22. An article comprising the film of claim 12.

23. The article of claim 22 that is an electronic device.
